(19) United States
(12) Patent Application Publication
(10) Pub. No.: US 2023/0336898 A1
(43) Pub. Date: Oct. 19, 2023

(54) SOUND GENERATION STRUCTURE

(71) Applicant: KOITO MANUFACTURING CO., LTD., Tokyo (JP)

(72) Inventors: Heisuke AMANO, Shizuoka-shi (JP); Masaru SASAKI, Shizuoka-shi (JP)

(73) Assignee: KOITO MANUFACTURING CO., LTD., Tokyo (JP)

(21) Appl. No.: 18/337,577

(22) Filed: Jun. 20, 2023

Related U.S. Application Data
(63) Continuation of application No. PCT/JP2022/000157, filed on Jan. 6, 2022.

(30) Foreign Application Priority Data
Jan. 8, 2021 (JP) 2021-002441
Jan. 8, 2021 (JP) 2021-002442
Jan. 8, 2021 (JP) 2021-002443

(51) Int. Cl. H04R 1/02; B60Q 5/00; B60Q 1/00

(52) U.S. Cl. CPC H04R 1/025; B60Q 5/00; B60Q 1/0017; H04R 1/028; H04R 2499/13

(57) ABSTRACT

A sound generation structure having a high flexibility in arrangement is provided. The sound generation structure includes: a speaker unit provided such that a front surface generating a sound faces a space outside a vehicle; and a lamp component constituting a part of a vehicle lamp. A closed space bounded by a plurality of components including the speaker unit and the lamp component is formed on a rear side of the speaker unit, and the speaker unit is bonded to an edge of an opening formed in one of the plurality of components.

### BACKGROUND

### 1. Field of the Invention

The present invention relates to a structure for generating sound outside a vehicle.

### 2. Description of the Related Art

In motor-driven vehicles such as hybrid vehicles and electric vehicles, motor sound during low-speed driving is so small that it is difficult for other vehicles and pedestrians to notice the driver's vehicle. In this background, a technology is proposed to generate a pseudo engine sound apart from the motor sound and use the pseudo engine sound to alert other vehicles and pedestrians. For example, a vibration apparatus for generating a vibrating sound by vibrating the front cover of a vehicle lamp is proposed (see patent literature 1).
[Patent Literature 1] JP2013-063757

The vibrator provided in the aforementioned vibrating apparatus is fixed at a position not visible from outside such that the front surface of the vibrator is in intimate contact with the inner surface of the front cover. Vibration caused by the vibrator is transmitted to the entirety of the front cover, and the front cover itself is vibrated to generate an alert sound. In this case, the vibrator should be in intimate contact with a component ultimately generating an alert sound. The related art also requires a space to provide the vibrator. Depending on the vehicle, it may be difficult to provide the vibration apparatus. Further, the magnitude and pitch of the alert sound depends on the shape, material, etc. of the component in intimate contact with the vibrator so that a restriction is imposed to the place where the vibration apparatus is provided.

### SUMMARY OF THE INVENTION

A sound generation structure according to an aspect of the present disclosure includes: a speaker unit provided such that a front surface generating a sound faces a space outside a vehicle; and a lamp component constituting a part of a vehicle lamp, wherein a closed space bounded by a plurality of components including the speaker unit and the lamp component is formed on a rear side of the speaker unit, and the speaker unit is bonded to an edge of an opening formed in one of the plurality of components.

A sound generation structure according to an aspect of the present disclosure includes: a lamp component constituting a part of a vehicle lamp; a speaker unit provided outside the vehicle lamp such that a front surface generating a sound faces a space outside a vehicle; and a fixing part that fixes the speaker unit to the lamp component. A closed space bounded by a plurality of components selected from the lamp component, the speaker unit, and the fixing part is formed on a rear side of the speaker unit, and the speaker unit is bonded to an edge of an opening formed in the fixing part.

A sound generation structure according to an aspect of the present disclosure includes: a lamp component constituting a part of a vehicle lamp, a speaker unit provided outside the vehicle lamp such that a front surface generating a sound faces a space outside a vehicle; and a fixing part that fixes the speaker unit to the lamp component, wherein a first space bounded by a plurality of components selected from the lamp component, the speaker unit, and the fixing part is formed on a rear side of the speaker unit, and the lamp component includes a port that establishes communication between a second space inside the vehicle lamp and the first space.

It is to be noted that any arbitrary combination or rearrangement of the above-described structural components and so forth is effective as and encompassed by the present embodiments. Moreover, this summary does not necessarily describe all necessary features so that the invention may also be a sub-combination of these described features.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a longitudinal sectional view showing an overview of a configuration of the vehicle lamp according to the first embodiment.

FIG. 2 is a cross-sectional view schematically showing an overview of a configuration of the sound generation structure according to the first embodiment.

FIG. 3 is a cross-sectional view schematically showing an overview of a configuration of the sound generation structure according to the second embodiment.

FIG. 4 is a cross-sectional view schematically showing an overview of a configuration of the sound generation structure according to the second embodiment.

FIG. 5 is a longitudinal sectional view showing an overview of a configuration of the vehicle lamp according to the fourth embodiment.

FIG. 6 is a front view of the outer lens of the vehicle lamp according to the fourth embodiment.

FIG. 7 is a D-D cross section of FIG. 6 and is a cross-sectional view schematically showing an overview of a configuration of the sound generation structure.

FIG. 8 is a cross-sectional view schematically showing an overview of a configuration of the sound generation structure according to the fifth embodiment.

FIG. 9 is a cross-sectional view schematically showing an overview of a configuration of the sound generation structure according to the sixth embodiment.

FIG. 10 is a cross-sectional view schematically showing an overview of a configuration of the sound generation structure according to the seventh embodiment.

FIG. 11 is a longitudinal sectional view showing an overview of a configuration of the vehicle lamp according to the eighth embodiment.

FIG. 12 is a longitudinal sectional view showing an overview of a configuration of the sound generation structure according to the eighth embodiment.

FIG. 13 is a cross-sectional view schematically showing an overview of a configuration of the sound generation structure according to the ninth embodiment near the port.

### DETAILED DESCRIPTION

### Summary of the Embodiment

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “one embodiment” may be used herein to refer to a single embodiment or multiple embodiments of the disclosure.

A sound generation structure according to an aspect of the present disclosure includes a speaker unit provided such that a front surface generating a sound faces a space outside a vehicle and a lamp component constituting a part of a vehicle lamp. A closed space bounded by a plurality of components including the speaker unit and the lamp component is formed on a rear side of the speaker unit, and the speaker unit is bonded to an edge of an opening formed in one of the plurality of components.

According to this aspect, the dedicated housing otherwise provided in the speaker unit can be embodied by the closed space bounded by the plurality of components including the speaker unit and the lamp component. Therefore, the speaker unit can be provided in a place where there are no spaces to provide a dedicated housing. Further, the sound generation structure according to this aspect does not generate a sound by vibrating the lamp component but outputs the sound generated by the speaker unit outside via the opening. Therefore, the sound generation structure can be provided in any place where an opening can be provided and a closed space can be formed on the rear side of the speaker unit. Given, for example, that the side where the vibrating plate of the speaker unit is provided is defined as the front side, the rear side is defined as the side opposite to the front side.

The outer edge of the speaker unit may be bonded to the edge of the opening over the entire circumference so as to seal the closed space from the space outside the vehicle. This can prevent water or dirt entering via the opening from invading the closed space.

The speaker unit may be provided such that the front surface faces downward relative to the vehicle. This makes it less likely that water or dirt enters via the opening.

The lamp component may be a lamp body constituting a lamp chamber in which the light source is provided. This makes it possible to provide the sound generation structure near the lamp chamber essentially located at the four corners of the vehicle and so makes it easy for the alert sound to be noticed by other vehicles and pedestrians around the vehicle.

The front surface of the speaker unit may be exposed outside the vehicle. This makes it easier for the alert sound to be noticed by other vehicles and pedestrians around the vehicle.

The volume of the closed space may be in a range 60-2000 cm³. This makes it possible for the speaker unit to generate a sound that can be easily recognized by pedestrians and drivers (e.g., appropriate sound pitch and sound pressure) efficiently.

The sound generation structure according to an aspect of the present disclosure includes a lamp component constituting a part of a vehicle lamp; a speaker unit provided outside the vehicle lamp such that a front surface generating a sound faces a space outside a vehicle; and a fixing part that fixes the speaker unit to the lamp component. A closed space bounded by a plurality of components selected from the lamp component, the speaker unit, and the fixing part is formed on a rear side of the speaker unit, and the speaker unit is bonded to an edge of an opening formed in the fixing part.

According to this aspect, the dedicated housing otherwise provided in the speaker unit may be implemented by the closed space bounded by the plurality of components selected from the lamp component, the speaker unit, and the fixing part. Therefore, the speaker unit can be provided in a place where there are no spaces to provide a dedicated housing. Further, the sound generation structure according to this aspect does not generate a sound by vibrating the lamp component but outputs the sound generated by the speaker unit outside via the opening. Therefore, the sound generation structure can be provided in any place where an opening can be provided and a closed space can be formed on the rear side of the speaker unit. Given, for example, that the side where the vibrating plate of the speaker unit is provided is defined as the front side, the rear side is defined as the side opposite to the front side.

The outer edge of the speaker unit may be bonded to the edge of the opening over the entire circumference so as to seal the closed space from the space outside the vehicle. This can prevent water or dirt entering via the opening from invading the closed space.

The closed space may be bounded by the lamp component, the speaker unit, and the fixing part. This makes it possible to form the closed space that embodies the housing of the speaker without increasing the number of components.

An adjustment part for adjusting the atmospheric pressure in the closed space may be formed in the fixing part. This can reduce the likelihood of troubles caused by an atmospheric pressure difference between the closed space and the space outside.

The speaker unit may be provided such that the front surface faces downward relative to the vehicle. This makes it less likely that water or dirt enters via the opening.

The lamp component may be a lamp body constituting the lamp chamber. This makes it possible to provide the sound generation structure near the lamp chamber essentially located at the four corners of the vehicle and so makes it easy for the alert sound to be noticed by other vehicles and pedestrians around the vehicle.

The front surface of the speaker unit may be exposed outside the vehicle. This makes it easier for the alert sound to be noticed by other vehicles and pedestrians around the vehicle.

The volume of the closed space may be in a range 60-400 cm³. This makes it possible for the speaker unit to generate a sound that can be easily recognized by pedestrians and drivers (e.g., appropriate sound pitch and sound pressure) efficiently.

The sound generation structure according to an aspect of the present disclosure includes a lamp component constituting a part of a vehicle lamp; a speaker unit provided outside the vehicle lamp such that a front surface generating a sound faces a space outside a vehicle; and a fixing part that fixes the speaker unit to the lamp component. A first space bounded by a plurality of components selected from the lamp component, the speaker unit, and the fixing part is formed on a rear side of the speaker unit, and the lamp component includes a port that establishes communication between a second space inside the vehicle lamp and the first space.

According to this aspect, it is possible to standardize the characteristic of the sound generated from the speaker unit by configuring the port to have a desired shape.

The port may project from the inner wall of the lamp component toward the second space.

The port may be tubular.

The cross-section area of the passage of the port may be 5-500 [mm²], and the length of the passage may be 2-100 [mm]. This can realize a sound having desired characteristics.

A cover provided at a distance from the speaker unit may further be provided on the front side of the speaker unit. The cover may be formed with an opening located to the side of the front surface of the speaker unit and may be configured such that the sound output from the front surface of the speaker unit is radiated outward from the opening. This makes it less likely for the speaker unit to be exposed to water or dirt invading via the opening.

The speaker unit may be provided such that the front surface faces downward relative to the vehicle.

The first space may be 60-400 [mm³]. The second space may be 60-2000 [mm³].

A description will be given of an embodiment of the present invention with reference to the drawings. In the explanations of the figures, the same elements shall be denoted by the same reference numerals, and duplicative explanations will be omitted appropriately. The configuration described below is by way of example only and does not limit the scope of the present invention.

### First Embodiment

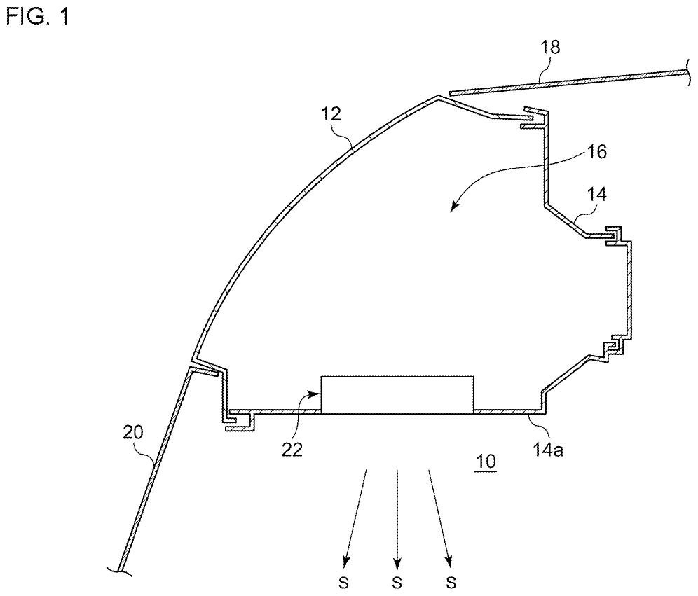

FIG. 1 is a longitudinal sectional view showing an overview of a configuration of the vehicle lamp according to the first embodiment. In FIG. 1, some of the components are omitted from the illustration. A vehicle headlamp 10 shown in FIG. 1 as a vehicle lamp includes an outer lens 12 provided to cause a light emitted from a light source (not shown) to be transmitted to a space in front of a vehicle and a lamp body 14 as a partition separating the light source and the vehicle body from each other. The outer lens 12 is integrated with the lamp body 14 to block the opening of the lamp body 14 on the front side of the vehicle and forms a lamp chamber 16 in which the light source is provided.

The vehicle headlamp 10 configured as described above is provided in a space between a vehicle hood 18 and a bumper 20. The vehicle headlamp 10 according to this embodiment is configured such that a sound generation structure 22 that generates an alert sound for other vehicles and pedestrians around the vehicle is provided on a bottom 14a of the lamp body 14 and toward the lamp (toward the lamp chamber 16).

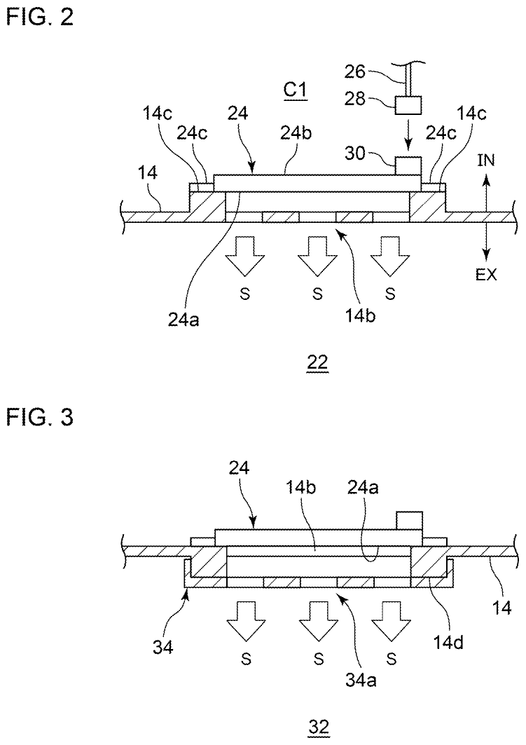

FIG. 2 is a cross-sectional view schematically showing an overview of a configuration of the sound generation structure 22 according to the first embodiment. The sound generation structure 22 includes a speaker unit 24 provided such that a front surface 24a generating a sound S faces a space EX outside the vehicle and a lamp body 14 as a lamp component constituting a part of a vehicle headlamp 10. An essential requirement for the speaker unit 24 is to generate a sound. For example, the speaker unit 24 may be structured to generate a sound by vibrating a vibrating plate by a voice coil and a magnet. The speaker unit 24 according to this embodiment is configured such that a vibrating plate is provided on the side of the front surface 24a of the disc-shaped main body. The lamp component may not be the lamp body 14 itself but may be another component integrated with the lamp body 14 or another component coupled to the lamp body 14.

In this embodiment, the lamp chamber 16 that is a closed space C1 bounded by a plurality of components including the speaker unit 24 and the lamp body 14 is formed on the side of a rear surface 24b of the speaker unit 24. It should be noted that the closed space C1 may be the entirety of the lamp chamber 16. Alternatively, the closed space C1 may be a space bounded by the speaker unit 24, the lamp body 14, and other members provided in the lamp chamber 16.

Given, for example, that the side where the vibrating plate of the speaker unit is provided is defined as the front side, the side of the rear surface 24b is the side opposite to the front side. A counter connector 30 connected to a connector 28 of a code 26 for transmitting a signal sent from an external sound source ECU is provided on the side of the rear surface 24b of the speaker unit 24.

The speaker unit 24 is, as shown in FIG. 2, bonded to an edge 14c of an opening 14b formed in the lamp body 14, which is one of the plurality of components. An outer edge 24c of the speaker unit 24 is bonded to the edge 14c of the opening 14b over the entire circumference so as to seal the closed space C1 from the space outside the vehicle. A variety of methods are available for bonding. For example, selection may be made as appropriate from adhesive fixing, screw fixing, fixing of components by fitting them together, etc. To improve the quality of sealing in the bonded portion, a sponge packing or an O ring may be provided between components. This can prevent water or dirt entering via the opening 14b from invading the closed space C1.

As described above, the sound generation structure 22 according to this embodiment is configured such that the dedicated housing otherwise provided in the speaker unit 24 is embodied by the closed space C1 bounded by the plurality of components including the speaker unit 24 and the lamp body 14. Therefore, the speaker unit 24 can be provided in a place where there are no spaces to provide a dedicated housing. Further, the sound generation structure 22 does not generate a sound by vibrating the outer lens 12 or the lamp body 14 but outputs the sound generated by the speaker unit 24 to the space EX outside the vehicle via the opening 14b. Therefore, the sound generation structure 22 can be provided in any place where the opening 14b can be provided and the closed space C1 can be formed on the side of the rear surface 24b of the speaker unit 24.

The speaker unit 24 may be provided such that the front surface 24a faces downward (downward in FIG. 2) relative to the vehicle. This makes it less likely that water or dirt enters via the opening 14b. The front surface 24a of the speaker unit 24 may be exposed outside the vehicle. This makes it easier for the alert sound to be noticed by other vehicles and pedestrians around the vehicle.

The lamp component according to this embodiment is the lamp body 14 constituting the lamp chamber 16 in which the light source is provided. This makes it possible to provide the sound generation structure near the lamp chamber of the headlamp or the tail lamp essentially located at the four corners of the vehicle and so makes it easy for the alert sound to be noticed by other vehicles and pedestrians all around the vehicle.

The volume of the closed space C1 is preferably in a range 60-2000 cm³. This makes it possible for the speaker unit 24 to generate a sound that can be easily recognized by pedestrians and drivers (e.g., appropriate sound pitch (frequency) and sound pressure (sound volume)) efficiently. Further, polypropylene (PPP) is favorable as the material of the lamp component constituting the closed space C1.

### Second Embodiment

FIG. 3 is a cross-sectional view schematically showing an overview of a configuration of the sound generation structure according to the second embodiment. A sound generation structure 32 shown in FIG. 3 is configured such that a cover 34 formed with a plurality of small openings 34a is provided outside the large opening 14b formed in the lamp body 14. The cylindrical cover 34 is screwed into an annular projection 14d provided outside the lamp body 14.

### Third Embodiment

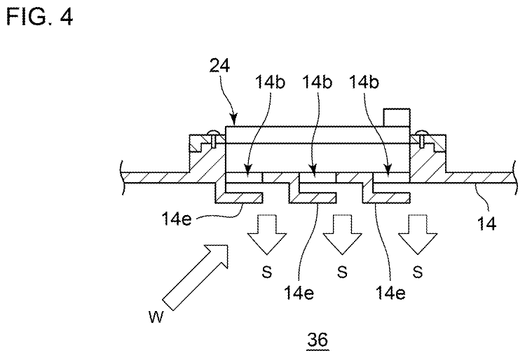

FIG. 4 is a cross-sectional view schematically showing an overview of a configuration of the sound generation structure according to the third embodiment. A sound generation structure 36 shown in FIG. 4 is configured such that a plurality of shielding parts 14e are provided at a position below and slightly distanced from the plurality of openings 14b formed in the lamp body 14 to make it less likely that the speaker unit 24 is directly exposed to water W from outside via the openings 14b. This makes it less likely for water W to invade the speaker unit 24 via the openings 14b, without blocking the sound S output from the openings 14b so much.

The present invention has been described with reference to the embodiments but is not limited to the embodiments described above. Appropriate combinations or replacements of the features of the respective embodiments are also encompassed by the present invention. Further, the embodiments may be modified by way of combinations, rearranging of the processing sequence, design changes, etc., based on the knowledge of a skilled person, and such modifications are also within the scope of the present invention.

### Fourth Embodiment

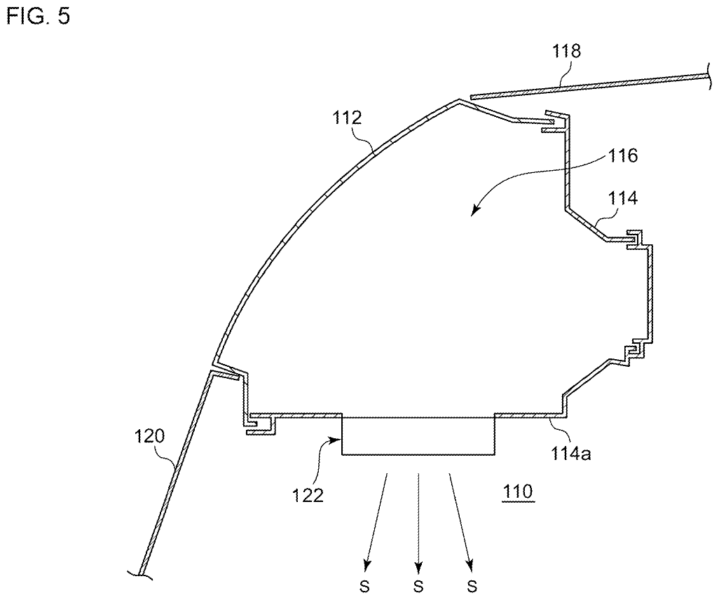

FIG. 5 is a longitudinal sectional view showing an overview of a configuration of the vehicle lamp according to the first embodiment. In FIG. 5, some of the components are omitted from the illustration. A vehicle headlamp 110 shown in FIG. 5 as a vehicle lamp includes an outer lens 112 provided to cause a light emitted from a light source (not shown) to be transmitted to a space in front of the vehicle and a lamp body 114 as a partition separating the light source and the vehicle body from each other. The outer lens 112 is integrated with the lamp body 114 to block the opening of the lamp body 114 on the front side of the vehicle and forms a lamp chamber 116 in which the light source is provided.

The vehicle headlamp 110 configured as described above is provided in a space between a vehicle hood 118 and a bumper 120. The vehicle headlamp 110 according to this embodiment is configured such that a sound generation structure 122 that generates an alert sound for other vehicles and pedestrians around the vehicle is provided on a bottom 114a of the lamp body 114 and toward the space outside the lamp.

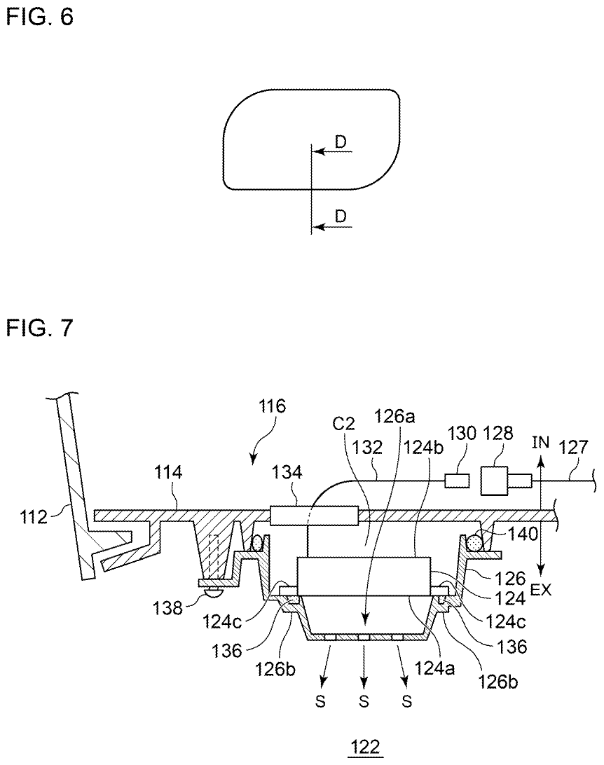

FIG. 6 is a front view of the outer lens of the vehicle lamp according to the fourth embodiment. FIG. 7 is a D-D cross section of FIG. 6 and is a cross-sectional view schematically showing an overview of a configuration of the sound generation structure 122. The sound generation structure 122 includes a lamp body 114 as a lamp component constituting a part of a vehicle headlamp 110, a speaker unit 124 provided such that a front surface 124a generating a sound S faces a space EX outside the vehicle, and an annular fixing part 126 that fixes the speaker unit 124 to the lamp body 114 such that the speaker unit 124 is spaced apart from the lamp body 114.

An essential requirement for the speaker unit 124 is to generate a sound. For example, the speaker unit 124 may be structured to generate a sound by vibrating a vibrating plate by a voice coil and a magnet. The speaker unit 124 according to this embodiment is configured such that a vibrating plate is provided on the side of the front surface 124a of the disc-shaped main body. The lamp component may not be the lamp body 114 itself but may be another component integrated with the lamp body 14 or another component coupled to the lamp body 114.

The sound generation structure 122 according to this embodiment is configured such that a closed space C2 bounded by a plurality of components selected from the lamp body 114, the speaker unit 124, and the fixing part 126 is formed on the side of a rear surface 124b of the speaker unit 124. Given, for example, that the side where the vibrating plate of the speaker unit is provided is defined as the front side, the side of the rear surface 124b is defined as the side opposite to the front side. A counter connector 130 connected to a connector 128 of a code 127 for transmitting a signal sent from an external sound source ECU is provided in the lamp chamber 116 on the side of the rear surface 124b of the speaker unit 124. A code 132 leading from the counter connector 130 extends through a bushing 134 provided in a hole formed in the lamp body 114 and is connected to the speaker unit 124.

The speaker unit 124 is, as shown in FIG. 7, bonded to an edge 126b of an opening 126a formed in the fixing part 126, which is one of the plurality of components. An outer edge 124c of the speaker unit 124 is bonded to the edge 126b of the opening 126a over the entire circumference so as to seal the closed space C2 from the space outside the vehicle. A variety of methods are available for bonding. For example, selection may be made as appropriate from fixing by an adhesive 136, fixing by a screw 138, fixing of components by fitting them together, etc. To improve the quality of sealing in the bonded portion, a sponge packing or an O ring 140 may be provided between components. This can prevent water or dirt entering via the opening 126a from invading the closed space C2.

As described above, the sound generation structure 122 according to this embodiment is configured such that the dedicated housing otherwise provided in the speaker unit 124 is embodied by the closed space C2 bounded by the plurality of components including the lamp body 114, the speaker unit 124 and the fixing part. Therefore, the speaker unit 124 can be provided in a place where there are no spaces to provide a dedicated housing. Further, the sound generation structure 122 does not generate a sound by vibrating the outer lens 112 or the lamp body 114 but outputs the sound generated by the speaker unit 124 to the space EX outside the vehicle via the opening 126a. Therefore, the sound generation structure 122 can be provided in any place where the opening 126a can be provided and the closed space C2 can be formed on the side of the rear surface 124b of the speaker unit 124.

The speaker unit 124 may be provided such that the front surface 124a faces downward (downward in FIG. 7) relative to the vehicle. This makes it less likely that water or dirt enters via the opening 126a. The front surface 124a of the speaker unit 124 may be exposed outside the vehicle. This makes it easier for the alert sound to be noticed by other vehicles and pedestrians around the vehicle.

Further, the lamp component according to this embodiment is the lamp body 114 constituting the lamp chamber 116 in which the light source is provided. This makes it possible to provide the sound generation structure near the lamp chamber of the headlamp or the tail lamp essentially located at the four corners of the vehicle and so makes it easy for the alert sound to be noticed by other vehicles and pedestrians all around the vehicle.

The volume of the closed space C2 is preferably in a range 60-400 cm³. This makes it possible for the speaker unit 124 to generate a sound that can be easily recognized by pedestrians and drivers (e.g., appropriate sound pitch (frequency) and sound pressure (sound volume)) efficiently. Further, polypropylene (PPP) or polybutylene terephthalate (PBT) is favorable as the material of the lamp component constituting the closed space C2, for example.

### Fifth Embodiment

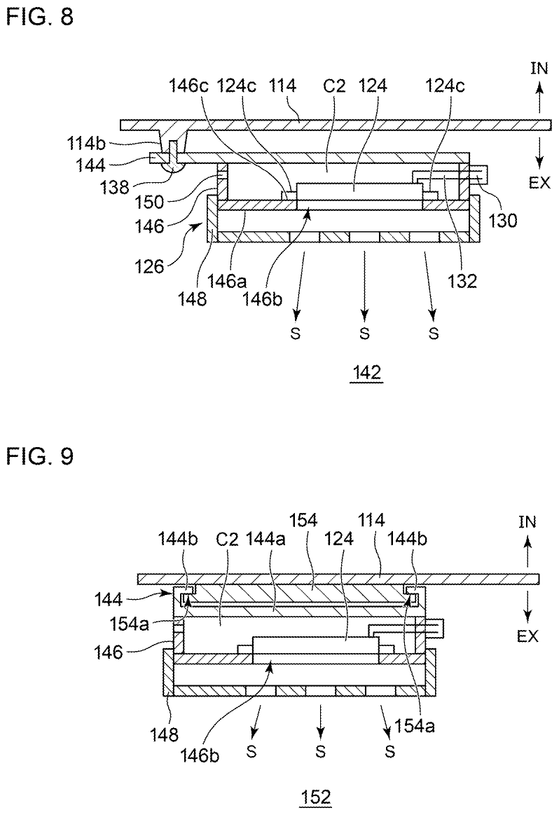

FIG. 8 is a cross-sectional view schematically showing an overview of a configuration of the sound generation structure according to the fifth embodiment. Those features identical to those of the sound generation structure according to the fourth embodiment are denoted by the same reference symbols, and a description thereof is omitted as appropriate. A sound generation structure 142 shown in FIG. 8 is configured such that a support plate 144 is fixed to a projection 114b projecting outside the lamp body 114 by a screw 138. A tubular component 146 is provided underneath the support plate 144, and an opening 146b is formed on one end face 146a of the tubular component 146. The outer edge 124c of the speaker unit 124 is adhesively fixed to an edge 146c of the opening 146b.

In this embodiment, the support plate 144 and the tubular component 146 form a fixing part. This forms a closed space C2 bounded by the tubular component 146 and the speaker unit 124. A through hole 150 in which a resin film for adjusting the atmospheric pressure in the closed space C2 is formed in the outer circumferential part of the tubular component 146. This makes it possible to reduce the likelihood of troubles caused by an atmospheric pressure difference between the closed space C2 and the space outside.

Further, the sound generation structure 142 according to this embodiment is configured such that a cover 148 provided at a distance from the speaker unit 124 is further provided on the side of the front surface 124a of the speaker unit 124. The cover 148 is a cylindrical component and is fixed to the outer circumferential part of the tubular component 146.

### Sixth Embodiment

FIG. 9 is a cross-sectional view schematically showing an overview of a configuration of the sound generation structure according to the sixth embodiment. Those features identical to those of the sound generation structure according to the fourth or fifth embodiment are denoted by the same reference symbols, and a description thereof is omitted as appropriate. A sound generation structure 152 shown in FIG. 9 is configured such that a pair of parallel guide grooves 154a are formed in a guide part 154 provided outside the lamp body 114. A pair of linear engaging parts 144b are provided on the side of a rear surface 144a (the surface toward the top of FIG. 5) of the support plate 144, which is a part of the fixing part, along the opposite two sides circumscribing the support plate 144 to project upward. As the engaging parts 144b are slid into the guide grooves 154a, the fixing part that includes the tubular component 146 and the support plate 144 are fixed to the lamp body 114.

### Seventh Embodiment

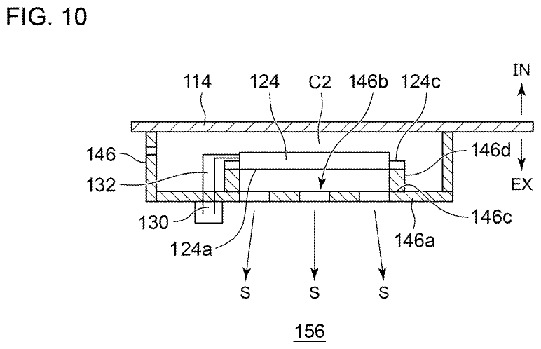

FIG. 10 is a cross-sectional view schematically showing an overview of a configuration of the sound generation structure according to the seventh embodiment. Those features identical to those of the sound generation structure according to the fourth-sixth embodiment are denoted by the same reference symbols, and a description thereof is omitted as appropriate. A sound generation structure 156 shown in FIG. 10 is configured such that the tubular component 146 is fixed outside the lamp body 114. Further, the opening 146b is formed on one end face 146a of the tubular component 146, and an annular projection 146d projecting toward the lamp body 114 is provided on the outer edge of the opening 146b. The outer edge 124c of the speaker unit 124 is adhesively fixed to the annular projection 146d.

The fixing part of this embodiment is embodied by the tubular component 146. Therefore, the closed space C2 is a space bounded by the lamp body 114, the speaker unit 124, and the tubular component 146. In this way, the closed space C2 embodying the housing of the speaker unit 124 can be formed without increasing the number of components. Further, the front surface 124a of the speaker unit 124 is exposed to the space EX outside the vehicle. This makes it easier for the alert sound to be noticed by other vehicles and pedestrians around the vehicle.

### Eighth Embodiment

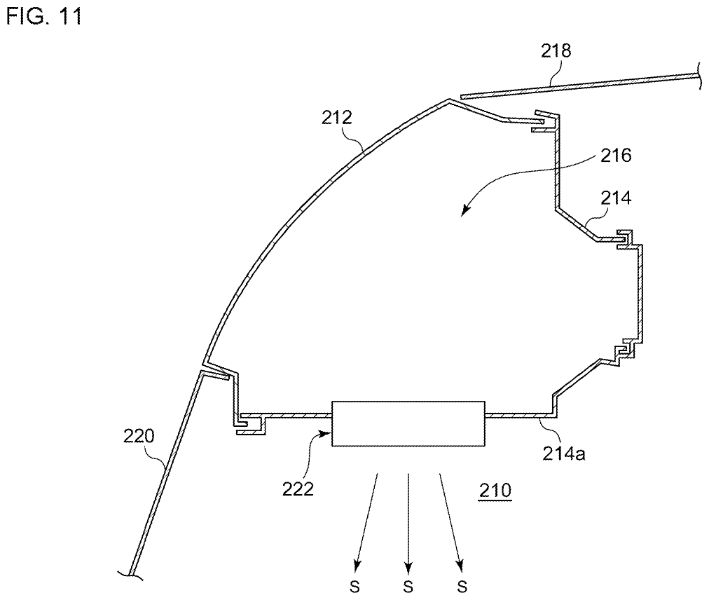

FIG. 11 is a longitudinal sectional view showing an overview of a configuration of the vehicle lamp according to the eighth embodiment. In FIG. 11, some of the components are omitted from the illustration. A vehicle headlamp 210 shown in FIG. 11 as a vehicle lamp includes an outer lens 212 provided to cause a light emitted from a light source (not shown) to be transmitted to a space in front of the vehicle and a lamp body 214 as a partition separating the light source and the vehicle body from each other. The outer lens 212 is integrated with the lamp body 214 to block the opening of the lamp body 214 on the front side of the vehicle and forms a lamp chamber 216 in which the light source is provided.

The vehicle headlamp 210 configured as described above is provided in a space between a vehicle hood 218 and a bumper 220. The vehicle headlamp 210 according to this embodiment is configured such that a sound generation structure 222 that generates an alert sound for other vehicles and pedestrians around the vehicle is provided on a bottom 214a of the lamp body 214 and toward the lamp (toward the lamp chamber 216).

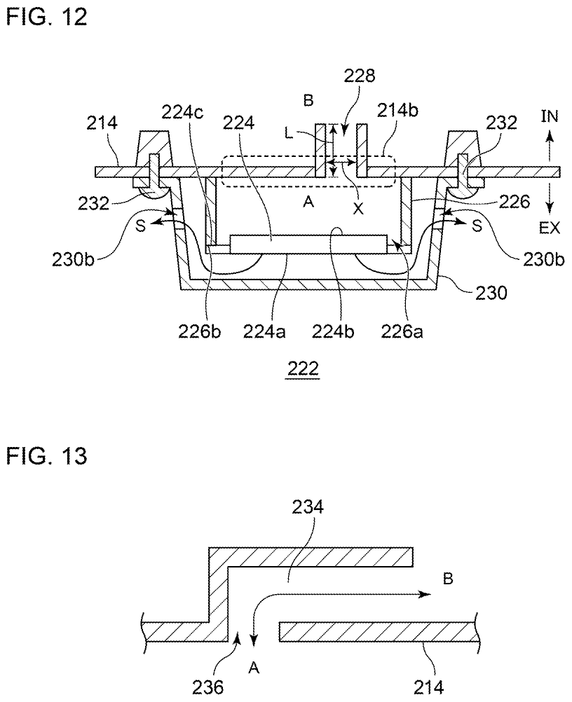

FIG. 12 is a longitudinal sectional view showing an overview of a configuration of the sound generation structure according to the eighth embodiment. The sound generation structure 222 includes a speaker unit 224 provided such that a front surface 224a generating a sound S faces a space EX outside the vehicle, a lamp body 214 as a lamp component constituting a part of a vehicle headlamp 210, and an annular fixing part 226 that fixes the speaker unit 224 to the lamp body 214 such that the speaker unit 224 is spaced apart from the lamp body 214.

An essential requirement for the speaker unit 224 is to generate a sound. For example, the speaker unit 224 may be structured to generate a sound by vibrating a vibrating plate by a voice coil and a magnet. The speaker unit 224 of the embodiment is configured such that a vibrating plate is provided on the side of the front surface 224a of the discs-shaped main body. The lamp component may not be the lamp body 214 itself but may be another component integrated with the lamp body 214 or another component coupled to the lamp body 214.

The sound generation structure 222 is configured such that a space A bounded by a plurality of components selected from the lamp body 214, the speaker unit 224, and the fixing part 226 is formed on the side of a rear surface 224b of the speaker unit 224. The lamp body 214 includes a port 228 that establishes communication between a space B toward the lamp chamber 216 of the vehicle headlamp 210 and the space A.

In this embodiment, the lamp chamber 216 that is the space B bounded by a plurality of components including the lamp body 214 is formed on the side of a rear surface 224b of the speaker unit 224. It should be noted that the space B may be entirety of the lamp chamber 216.

Alternatively, the space B may be a space bounded by the lamp body 214 and other members provided in the lamp chamber 216. Given, for example, that the side where the vibrating plate of the speaker unit 224 is provided is defined as the front side, the side of the rear surface 224b is defined as the side opposite to the front side.

The speaker unit 224 is, as shown in FIG. 12, bonded to an edge 226b of an opening 226a of the fixing part 226 provided in the lamp body 214, which is one of the plurality of components, toward the space EX outside the vehicle. An outer edge 224c of the speaker unit 224 is bonded to the edge 226b of the opening 226a of the fixing part 226 over the entire circumference so as to seal the space A from the space EX outside the vehicle. A variety of methods are available for bonding. For example, selection may be made as appropriate from adhesive fixing, screw fixing, fixing of components by fitting them together, etc. To improve the quality of sealing in the bonded portion, a sponge packing or an O ring may be provided between components. This can prevent water or dirt entering from the space EX outside the vehicle from invading the space A.

Further, the sound generation structure 222 according to this embodiment is configured such that a cover 230 provided at a distance from the speaker unit 224 is further provided on the side of the front surface 224a of the speaker unit 224. The cover 230 is a component having a shape of a truncated cone, and a flange part 230a is fixed to the lamp body 214 by a screw 232.

The cover 230 is formed with an opening 230b located to the side of the front surface 224a of the speaker unit 224 and may be configured such that the sound output from the front surface 224a of the speaker unit 224 is radiated outward from the opening 230b. This makes it less likely for the speaker unit 224 to be exposed to water or dirt invading via the opening 230b. Further, the direction in which the sound flows can be adjusted by changing the position of the opening 230b.

As described above, the sound generation structure 222 according to this embodiment is configured such that the dedicated housing otherwise provided in the speaker unit 224 is embodied by the space A and the space B bounded by the plurality of components including the speaker unit 224 and the lamp body 214. Therefore, the speaker unit 224 can be provided in a place where there are no spaces to provide a dedicated housing. Further, the sound generation structure 222 does not generate a sound by vibrating the outer lens 212 or the lamp body 214 but outputs the sound generated by the speaker unit 224 to the space EX outside the vehicle via the opening 230b. Therefore, the sound generation structure 222 can be provided in any place where the opening 230b can be provided and the space A and the space B can be formed on the side of the rear surface 224b of the speaker unit 224.

The speaker unit 224 is provided such that the front surface 224a faces downward (downward in FIG. 12) relative to the vehicle. This makes it less likely that water or dirt enters via the opening 230b.

The lamp component according to this embodiment is the lamp body 214 constituting the lamp chamber 216 in which the light source is provided. This makes it possible to provide the sound generation structure near the lamp chamber of the headlamp or the tail lamp essentially located at the four corners of the vehicle and so makes it easy for the alert sound to be noticed by other vehicles and pedestrians all around the vehicle.

### Function of Port

A description will now be given of the function of the port 228. The lamp body 214 is configured such that the port 228 is formed in a rear wall 214b located toward the rear surface 224b of the sound generation structure 222. The port 228 is provided to adjust the speaker characteristics. The magnitude of acoustic coupling of the space A and the space B is adjusted mainly by the cross-section area X and the length L. Therefore, the characteristics of the sound generated by the speaker unit can be standardized by configuring the port 228 to have a desired shape. In this case, the sound characteristics include sound pressure (sound volume) and frequency (sound pitch).

In a comparison with the case where a port is not provided in the rear wall 214b of the lamp body 214, the following advantages are obtained by providing the port 228 as described above. Provided that a port is not provided in the rear wall 214b of the lamp body 214 and the space A is a closed space, it is difficult to produce a low-pitched sound (stated otherwise, the sound range is shifted to a higher range) if the volume of the space is small. If the rear wall 214b is not provided and the space A and the space B are connected, on the other hand, the volume will be large so that it will be easy to produce a low-pitched sound. However, the acoustic characteristic would change due to other structures in the lamp chamber 216 so that it will be difficult to standardize the acoustic characteristic for each vehicle type.

Thus, it is possible to output a desired sound from the sound generation structure 222 despite a difference in the configuration of the lamp chamber 216, by adjusting the acoustic coupling of the space A and the space B according to the shape (cross-section area and length) of the port 228. The larger the cross-section area of the port 228 and the smaller the length thereof, the larger the acoustic coupling. Stated otherwise, the smaller the cross-section area of the port 228 and the larger the length thereof, the smaller the acoustic coupling. A larger acoustic coupling increases a low-pitched sound but increases an impact on the acoustic characteristic from structures in the lamp chamber 216. Conversely, a smaller acoustic coupling reduces a low-pitched sound but reduces an impact on the acoustic characteristic from structures in the lamp chamber 216.

The port 228 according to this embodiment has a shape of a tube (cylinder or polygonal tube) and projects from the inner side of the rear wall 214b of the lamp body 214 toward the space B. The cross-section area X of the passage of the port 228 may be 5-500 [mm²], and the length L of the passage may be 2-100 [mm]. Further, the space A may be in a range 60-400 [mm³]. The space B may be in a range 60-2000 [mm³]. Further, polypropylene (PPP) or polybutylene terephthalate (PBT) is favorable as the material of the lamp component constituting the space A and the space B, for example. This makes it possible for the speaker unit 224 to generate a sound having desired characteristics that can be easily recognized by pedestrians and drivers. The sound having desired characteristics means a sound having a sound pressure and frequency in compliance with the regulations on devices for alerting of approaching vehicles stipulated in respective countries.

### Ninth Embodiment

FIG. 13 is a cross-sectional view schematically showing an overview of a configuration of the sound generation structure according to the ninth embodiment near the port. A port 234 shown in FIG. 13 has a shape that leads from an opening formed in the lamp body 214 to the space B via a curved route.

While the preferred embodiments of the present invention have been described using specific terms, such description is for illustrative purposes only, and it is to be understood that changes and variations may be made without departing from the spirit or scope of the appended claims.

What is claimed is:

1. A sound generation structure comprising:
a speaker unit provided such that a front surface generating a sound faces a space outside a vehicle; and
a lamp component constituting a part of a vehicle lamp, wherein
a closed space bounded by a plurality of components including the speaker unit and the lamp component is formed on a rear side of the speaker unit, and
the speaker unit is bonded to an edge of an opening formed in one of the plurality of components.

2. The sound generation structure according to claim 1, wherein
an outer edge of the speaker unit is bonded to the edge of the opening over the entire circumference so as to seal the closed space from a space outside the vehicle.

3. The sound generation structure according to claim 1, wherein
the speaker unit is provided such that the front surface faces downward relative to the vehicle.

4. The sound generation structure according to claim 1, wherein
the lamp component is a lamp body constituting a lamp chamber in which a light source is provided.

5. The sound generation structure according to claim 1, wherein
the front surface of the speaker unit is exposed outside the vehicle.

6. The sound generation structure according to claim 1, wherein
a volume of the closed space is in a range 60-2000 cm³.

7. A sound generation structure comprising:
a lamp component constituting a part of a vehicle lamp,
a speaker unit provided outside the vehicle lamp such that a front surface generating a sound faces a space outside a vehicle; and
a fixing part that fixes the speaker unit to the lamp component, wherein
a closed space bounded by a plurality of components selected from the lamp component, the speaker unit, and the fixing part is formed on a rear side of the speaker unit, and
the speaker unit is bonded to an edge of an opening formed in the fixing part.

8. The sound generation structure according to claim 7, wherein
the outer edge of the speaker unit is bonded to the edge of the opening over the entire circumference so as to seal the closed space from the space outside the vehicle.

9. The sound generation structure according to claim 7, wherein
the closed space is bounded by the lamp component, the speaker unit, and the fixing part.

10. The sound generation structure according to claim 7, wherein
an adjustment part for adjusting an atmospheric pressure in the closed space is formed in the fixing part.

11. The sound generation structure according to claim 7, wherein
the speaker unit is provided such that the front surface faces downward relative to the vehicle.

12. The sound generation structure according to claim 7, wherein
the lamp component is a lamp body constituting a lamp chamber in which a light source is provided.

13. The sound generation structure according to claim 7, wherein
the front surface of the speaker unit is exposed outside the vehicle.

14. The sound generation structure according to claim 7, wherein
a volume of the closed space is in a range 60-400 cm³.

15. A sound generation structure comprising:
a lamp component constituting a part of a vehicle lamp,
a speaker unit provided outside the vehicle lamp such that a front surface generating a sound faces a space outside a vehicle; and
a fixing part that fixes the speaker unit to the lamp component, wherein
a first space bounded by a plurality of components selected from the lamp component, the speaker unit, and the fixing part is formed on a rear side of the speaker unit, and
the lamp component includes a port that establishes communication between a second space inside the vehicle lamp and the first space.

16. The sound generation structure according to claim 15, wherein
the port projects from an inner wall of the lamp component toward the second space.

17. The sound generation structure according to claim 15, wherein
the port is tubular.

18. The sound generation structure according to claim 15, wherein
a cross-section area of a passage of the port is 5-500 [mm²], and a length of the passage is 2-100 [mm].

19. The sound generation structure according to claim 15, wherein
a cover provided at a distance from the speaker unit is further provided on a front side of the speaker unit, and
the cover is formed with an opening located to a side of the front surface of the speaker unit and is configured such that a sound output from the front surface of the speaker unit is radiated outward from the opening.

20. The sound generation structure according to claim 15, wherein
the speaker unit is provided such that a front surface faces downward relative to the vehicle.

21. The sound generation structure according to claim 15, wherein
the first space is 60-400 [mm³], and
the second space is 60-2000 [mm³].
